(19) United States
(12) Patent Application Publication
(10) Pub. No.: US 2026/0240150 A1
(43) Pub. Date: Aug. 20, 2026

(54) SOLID ACIDIC EFFERVESCENT ANTIMICROBIAL COMPOSITION AND METHOD OF USE

(71) Applicant: ECOLAB USA INC., Saint Paul, MN (US)

(72) Inventors: Derrick Anderson, Vadnais Heights, MN (US); Emily Olson, Minneapolis, MN (US); Erik C. Olson, Eagan, MN (US); Rosalind Haas, Saint Paul, MN (US); Ryan Giffin Moore, Lilburn, GA (US); Wendy Lo, Woodbury, MN (US)

(21) Appl. No.: 19/536,507

(22) Filed: Feb. 11, 2026

Related U.S. Application Data
(60) Provisional application No. 63/758,482, filed on Feb. 14, 2025.

(51) Int. Cl. A01N 25/18; A01N 25/30; A01N 37/04; A01N 37/10; A01P 1/00

(52) U.S. Cl. CPC A01N 25/18; A01N 25/30; A01N 37/04; A01N 37/10; A01P 1/00

(57) ABSTRACT

Solid acidic effervescent compositions providing antimicrobial efficacy with desired dissolution times are disclosed. Pressed solid acid tablets with effervescent characteristics to readily dissolve in water for use as an antimicrobial composition, including for various hard surface cleaning applications, including for consumer and institutional uses as disinfectants, are further disclosed. Aqueous solutions and methods of using aqueous solutions of the solid acid tablets are also disclosed.

### CROSS-REFERENCE TO RELATED APPLICATIONS

This application claims priority under 35 U.S.C. § 119 to Provisional Application U.S. Ser. No. 63/758,482, filed on Feb. 14, 2025, which is herein incorporated by reference in its entirety.

### TECHNICAL FIELD

The disclosure relates generally to solid acidic effervescent compositions providing antimicrobial efficacy with desired dissolution times for convenient application of use. The present disclosure provides pressed solid acid tablets with effervescent characteristics to readily dissolve in water for use as an antimicrobial composition, including for various hard surface cleaning applications, including for consumer and institutional uses as disinfectants.

### BACKGROUND

There is an ongoing demand for solid compositions to replace liquid formulations in both consumer and institutional products. Solid compositions provide sustainability benefits due to the reduction in packaging of a solid composition compared to a liquid counterpart that is often largely made up of water. Solids are known to reduce shipping costs and burdens, as well as storage requirements of liquids compared to solids in terms of both shelf stability as well as space required to store the products. In many consumer and institutional settings, use of solids to generate a use solution for a particular application is desirable for each of these reasons over use of a liquid counterpart.

Tablets provide individual doses of cleaning compositions which many consumers find to be more convenient than traditional liquid or powder forms. Tablets also eliminate the need for measuring, resulting in precise dosing and avoiding wasteful overdosing or underdosing, making them easier to handle and dispense. For at least these reasons, cleaning products in tablet form have become very popular.

There is an ongoing need to provide solid compositions, including tablets, suitable for a variety of uses both consumer and institutional. However, there is often a challenge in providing solid compositions that are able to quickly dissolve into a use solution. Users do not want the unnecessary delay in time it takes for a solid to dissolve into a use solution, nor the large volumes and/or extremely high water temperatures it can take for a solid compositions to dissolve into a use solution.

It is therefore an object of this disclosure to provide solid tablet compositions suitable for a variety of uses both consumer and institutional.

It is still another object of this disclosure to formulate solid tablet compositions that have effervescent characteristics as a result of formulation to readily dissolve into a use solution in a desired slow or fast dissolution rate based on a user's preference.

It is a further object of the disclosure to provide solid tablet compositions that are able to quickly dissolve into a use solution within about 60 minutes or less, depending upon either a slow of fast dissolution rate.

It is another object of this disclosure to formulate solid tablet compositions that are solid acids to provide desired antimicrobial efficacy.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is an object, feature, and/or advantage of the present disclosure to provide a solid tablet composition comprising: a solid organic acid or salt thereof; a sulfate and/or sulfonate anionic surfactant; an alkali metal carbonate and/or bicarbonate effervescent base; and at least one additional functional ingredient, preferably comprising a filler, and preferably wherein the weight ratio of solid organic acid or salt thereof to the alkali metal carbonate and/or bicarbonate effervescent base is from about 6:1 to about 1:5.

It is a further object, feature, and/or advantage of the present disclosure to provide a use solution of a tablet composition comprising: an aqueous solution of the tablet composition according to any one of the embodiments described herein, wherein the aqueous solution has a pH between about 2 and about 6, preferably about 2 to about 4.

It is a further object, feature, and/or advantage of the present disclosure to provide a method of use comprising: adding a tablet composition according to any one of embodiments described herein into an aqueous solution to dissolve the tablet composition to form a use solution within about 15 minutes or less, contacting a surface with the use solution, and disinfecting the surface; or contacting the use solution according to any one of the embodiments described herein with a surface, and disinfecting the surface.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows the results of the hard water clarity test for formulations VI (A-C) through VIII at a 7% use solution in 17 gpg water.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been surprisingly found that acidic antimicrobial tablet compositions provide desired antimicrobial efficacy in tablet form benefiting from effervescence that provides fast dissolution times to provide use solutions of the compositions.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 11/2, and 43/4. This applies regardless of the breadth of the range.

All publications, including all patents, patent applications and other patent and non-patent publications cited or mentioned herein are incorporated herein by reference for at least the purposes that they are cited; including for example, for the disclosure or descriptions of methods of materials which may be used. Nothing herein is to be construed as an admission that a publication or other reference (including any reference cited in the Background section) is prior art to the invention or that the invention is not entitled to antedate such disclosure, for example, by virtue of prior invention.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, molecular weight, soil removal, log reduction, temperature, pH, humidity, ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can affect two kinds of microbial cell damage. The first is a lethal, irreversible action resulting in complete microbial cell destruction or incapacitation. The second type of cell damage is reversible, such that if the organism is rendered free of the agent, it can again multiply. The former is termed microbiocidal and the later, microbistatic. A sanitizer and a disinfectant are, by definition, agents which provide antimicrobial or microbiocidal activity. In contrast, a preservative is generally described as an inhibitor or microbistatic composition. As referred to herein, antimicrobial compositions are further suitable for cidal activity against viral pathogens. For the purpose of this patent application, successful virucidal reduction is achieved when the viral populations are completely inactivated.

As used herein, the term “between” is inclusive of any endpoints noted relative to a described range.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The term “commercially acceptable cleaning performance” refers generally to the degree of cleanliness, extent of effort, or both that a typical consumer would expect to achieve or expend when using a cleaning product or cleaning system to address a typical soiling condition on a typical substrate. This degree of cleanliness may, depending on the particular cleaning product and particular substrate, correspond to a general absence of visible soils, or to some lesser degree of cleanliness. Cleanliness may be evaluated in a variety of ways depending on the particular cleaning product being used and the particular hard or soft surface being cleaned, and normally may be determined using generally agreed industry standard tests or localized variations of such tests. In the absence of such agreed industry standard tests, cleanliness may be evaluated using the test or tests already employed by a manufacturer or seller to evaluate the cleaning performance of its phosphorus-containing cleaning products sold in association with its brand. In some aspects, the methods provide commercially acceptable cleaning performance while ensuring the formulations do not leave hazy, streaky, or tacky residues on treated surfaces.

As used herein, the phrase “consumer” refers to a non-institutional use as well as the purchaser who intends to use a product or a commodity for a non-industrial and business use, such as a use of a product within a consumer's own home.

As used herein, the term “disinfectant” refers to an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). Disinfectants provide various levels of disinfection. As used herein, the term “high level disinfection” or “high level disinfectant” refers to a compound or composition that kills substantially all organisms, except high levels of bacterial spores, and is effected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

As referred to herein, disinfectant achieves total kill and provides improvement over sanitizing agents that reduces the number of bacterial contaminants to safe levels as judged by public health requirements. In an embodiment, sanitizers provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives. Beneficially the use of compositions described herein provide disinfection of the various food processing surfaces.

As used herein, the phrase “food product” includes any food substance that might require treatment with an antimicrobial agent or composition and that is edible with or without further preparation. Food products include meat (e.g. red meat and pork), seafood, poultry, produce (e.g., fruits and vegetables), eggs, living eggs, egg products, ready to eat food, wheat, seeds, roots, tubers, leafs, stems, corns, flowers, sprouts, seasonings, or a combination thereof. The term “produce” refers to food products such as fruits and vegetables and plants or plant-derived materials that are typically sold uncooked and, often, unpackaged, and that can sometimes be eaten raw.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “generally” encompasses both “about” and “substantially.”

The term “hard surface” refers to a solid, substantially non-flexible surface such as a counter top, tile, floor, wall, panel, window, plumbing fixture (e.g. drain), kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, marble, porcelain, etc. Hard surfaces may include for example, health care surfaces and food processing surfaces.

As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.), or fabric surfaces, e.g., knit, woven, and non-woven surfaces (such as surgical garments, draperies, bed linens, bandages, etc.,), or patient-care equipment (such as respirators, diagnostic equipment, shunts, body scopes, wheel chairs, beds, etc.,), or surgical and diagnostic equipment. Health care surfaces include articles and surfaces employed in animal health care.

As used herein, the term “institutional” is meant that the use or operations are located in a commercial or service industry including but not limited to hotels, motels, hospitals, nursing homes, restaurants, bars, health clubs, schools, colleges, universities, and the like.

As used herein the term “molecular weight” refers to the mass of a molecule based on the chemical formula. The term “molecular weight” in referring to a polymer refers to the weight average molecular weight (Mw) that is calculated by taking the weight average of the molecular weights of individual monomers in a polymer. The specific method used to determine molecular weight will depend on the nature of the molecule and the available techniques. Examples of common methods to determine molecular weight include mass spectrometry, size exclusion chromatography (SEC), light scattering, osmometry, chemical analysis and viscometry.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x” mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “surfactant” or “surface active agent” refers to an organic chemical that when added to a liquid changes the properties of that liquid at a surface.

As used herein, “tablet” refers to any unitary solid form preparation where the dosage of each unit is fixed by size and weight. Tablets can be of any shape and can be prepared using any method known in the art, including compression, casting, briquetting, injection molding and extrusion. In preferred embodiments the solid tablet compositions are prepared by tablet pressing. In preferred embodiments the solid tablet compositions are prepared by a rotary tablet press.

As used herein the terms “use solution,” “ready to use,” or variations thereof refer to a composition that is diluted, for example, with water, to form a use composition having the desired components of active ingredients for the intended use. For reasons of economics, a concentrate can be marketed, and an end-user can dilute the concentrate with water or an aqueous diluent to a use solution.

As used herein, the term “virucidal” refers to an agent that reduces the number of viruses on a surface or substrate. In an embodiment, virucidal compositions will provide at least a 3-log order reduction, at least a 4-log order reduction, or preferably a 5-log order reduction, or more preferably a complete inactivation of viruses. These reductions can be evaluated using a procedure set out in ASTM E1053 Standard Test Method for Efficacy of Virucidal Agents Intended for Inanimate Environmental Surfaces; US standards are set forth in EPA 810.2200. According to this reference a virucidal composition should provide a 99.9% reduction (3-log order reduction) for virucidal activity.

The term “virus”, as used herein refers to a type of microorganism that can include both pathogenic and non-pathogenic viruses. Pathogenic viruses can be classified into two general types with respect to the viral structure: enveloped viruses and non-enveloped viruses. Some well-known enveloped viruses include herpes virus, influenza virus; paramyxovirus, respiratory syncytial virus, corona virus, HIV, hepatitis B virus, hepatitis C virus and SARS-COV virus. Non-enveloped viruses, sometimes referred to as “naked” viruses, include the families Picornaviridae, Reoviridae, Caliciviridae, Adenoviridae and Parvoviridae. Members of these families include rhinovirus, poliovirus, adenovirus, hepatitis A virus, norovirus, papillomavirus, and rotavirus. It is known in the art that “enveloped” viruses are relatively sensitive and, thus, can be inactivated by commonly used disinfectants. In contrast, non-enveloped viruses are substantially more resistant to conventional disinfectants and are significantly more environmentally stable than enveloped viruses.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Tablet Compositions

According to embodiments, the tablet compositions are pressed tablets and include solid acids (in embodiments solid organic acids, solid inorganic acids, and/or salts thereof), sulfate and/or sulfonate anionic surfactant, an alkali metal carbonate and/or bicarbonate effervescent base, and at least one additional functional ingredient (in embodiments at least one filler). The tablet compositions can further include additional functional ingredients. The tablet compositions are made of homogenous mixtures of the components described herein.

Exemplary tablet compositions are shown in Table 1 in weight percentages. While the components may have a percent actives of 100%, it is noted that Tables 1A-1B does not recite the percent actives of the components, but rather, recites the total weight percentage of the raw materials (i.e. active concentration plus inert ingredients, such as water).

According to embodiments the tablet compositions described in Tables 1A-1B preferably include a weight ratio of acid content (Solid Inorganic and/or Organic Acids) to carbonate (Effervescent Bases) from about 6:1 to about 1:5 to achieve desired effervescence and dissolution of the tablet compositions. The weight ratio of acid content to carbonate (effervescent bases) can be impacted by the inclusion of other acidic components of the tablet compositions. For example, the filler Glucono delta lactone is a sugar that is dissolved into acid form and would further contribute to an acid: base ratio in a use solution. However, one skilled in the art will ascertain that the outlined weight ratios of acid content (Solid Inorganic and/or Organic Acids) to carbonate (Effervescent Bases) can have interference with other components. According to further embodiments the tablet compositions described in Tables 1A-1B preferably wherein when the sulfate and/or sulfonate anionic surfactant comprise Sodium lauryl sulfate (SLS) and alpha olefin sulfonate (AOS) the weight ratio of SLS to AOS is from about 2:1 to about 1:2, or preferably about 1.5:1 to about 2:1. Without being limited to a particular theory of the invention, preferred tablet compositions having the defined ratio provide hard water tolerance and low streaking of treated surfaces.

TABLE 1A

| | First | Second | Third |
|---|---|---|---|
| | Exemplary | Exemplary | Exemplary |
| Material | Range wt.-% | Range wt.-% | Range wt.-% |
| Solid Organic Acids | 40-80 | 45-80 | 50-80 |
| Effervescent Bases | 5-40 | 10-40 | 10-30 |
| Anionic Surfactant | 1-20 | 2-20 | 2-15 |
| Fillers | 0-25 | 5-25 | 5-20 |
| Optional Additional | 0-25 | 0-20 | 0-15 |
| Functional Ingredients | | | |
| Total | 100 | 100 | 100 |

TABLE 1B

| | First | Second | Third |
|---|---|---|---|
| | Exemplary | Exemplary | Exemplary |
| Material | Range wt.-% | Range wt.-% | Range wt.-% |
| Solid Inorganic and/or | 40-80 | 45-80 | 50-80 |
| Organic Acids | | | |
| Effervescent Bases | 5-40 | 10-40 | 10-30 |
| Anionic Surfactant | 1-20 | 2-20 | 2-15 |
| Fillers | 0-25 | 5-25 | 5-20 |
| Optional Additional | 0-25 | 0-20 | 0-15 |
| Functional Ingredients | | | |
| Total | 100 | 100 | 100 |

The tablet compositions are solids with dimensional stability, including kinetic and thermodynamic stability. In an aspect, the solid tablet compositions are dimensionally stable and have a growth exponent (which is a measurement of change in dimension of the solid) of less than about 3% if heated at a temperature up to approximately 120° F. for at least one hour at relative humidity, or less than about 3% if heated at a temperature of approximately 104° F. for at least one hour o at a humidity between about 40-65%.

The tablet compositions are pressed solids. The compositions can be made by combining raw materials into a homogenous mixture before pressing the compositions into a desired shape and size. In embodiments the tablets can have any desired diameter, such as a diameter of between about 5 mm and about 75 mm, or preferably a diameter between about 0.5 inches and about 2 inches (about 12 mm and about 50 mm). In some applications, the tablets have a diameter of at least 5 mm, at least 10 mm, at least 15 mm, at least 20 mm, at least 25 mm, at least 30 mm, at least 35 mm, at least 40 mm, at least 45 mm, at least 50 mm, at least 55 mm, at least 60 mm or at least 70 mm. The tablets compositions described herein can be of any weight, such as a weight between 100 mg and 100 g. In preferred embodiments the tablet compositions have a weight between about 5 g to about 30 g.

In some embodiments it is desirable for the tablet compositions to have a size and dissolution between about 0.5-20 grams tablet per Liter water for dissolution, and preferably between about 2-10 grams tablet per Liter water for dissolution.

In each of the embodiments described herein for the tablet compositions, the size, shape, stability, hardness, etc. provide solid tablets that are dissolved in water to form a use solution within about 10 minutes or less in an aqueous solution at a temperature of at least about 40° C. (104° F.), or form a use solution within about 15 minutes or less in an aqueous solution of cold water of about 20° C. (68° F.) or less.

The tablet compositions are substantially free of water. In embodiments the compositions have less than about 1 wt-% water, preferably less than about 0.5 wt-% water. In preferred embodiments water is not added into the tablet compositions; however small amounts of water can be included that do not negatively impact the dimensional stability, hardness and other features described herein.

Any tableting equipment known in the art can be used for tablet formation. Suitable equipment includes a standard single stroke or a rotary press. Such presses are commercially available, and are available from, e.g., Carver, Inc. (Wabash, Ind.), Compression Components & Service, LLC (Warrington, Pa.), Specialty Measurements Inc. (Lebanon, N.J.), GEA Pharma Systems (Wommelgem, Belgium), Korsch America Inc. (South Easton, Mass.), Elizabeth Companies (North Huntingdon, PA) or Bosch Packaging Technology (Minneapolis, Minn.).

The tablet compositions can be made at room temperature (21° C. or 70° F.) under atmospheric pressure, and is not adversely affected by temperature or pressure conditions. However, high humidity can have a negative impact on tableting. The tablet can be compressed by applying a compression pressure of at least about 1500 PSI, preferably at least 1750 PSI. In some applications, the tablet is compressed applying a compression pressure of at least 2000 PSI, or at least 2500 PSI, or at least 5000 PSI, or at least 7500 PSI, or greater. The use of pressed solids provides numerous benefits over conventional solid block or tablet compositions, which can require high pressure in a tablet press, or casting requiring the melting of a composition consuming significant amounts of energy, and/or extrusion requiring expensive equipment and advanced technical expertise. Moreover, pressed solid compositions retain their shape under conditions where the compositions may be stored or handled.

The compositions beneficially do not require a heated or cooled curing step to solidify into a stable solid composition. The amount of time the compositions are cured depends on a variety of factors, including, but not limited to, the desired rigidity of the solid composition, the ingredients present in the solid, and the desired end use of the solid. In some embodiments, the compositions are cured for at least about 30 minutes, at least about 1 hour, at least about 1 day, or at least about 1 week. In other embodiments, the compositions are cured for about 15 to about 30 minutes. The compositions are cured at ambient temperature. That is, the compositions do not require heating or cooling during the cure step.

The tablet compositions have a tablet hardness that exhibits or provides an optimal operating range for both tablet hardness and the desired product aesthetics and dissolution characteristics described herein. In embodiments, the tablet composition can have a tablet hardness between about 10-60 lb·f. As an example, such hardness can be measured by placing a tablet in an IMADA 44 force gauge (IMADA, Inc. Northbrook IL) wherein the diameter is in the vertical position. The meter is manually operated by applying force to the tablet until the tablet breaks. The peak force measurement is then recorded as the break strength of the tablet tested.

The tablet compositions are beneficially safe to handle tablets and do not require personal protective equipment (PPE). PPE may include, for example, goggles, eye wash stations, masks and other protective equipment.

The compositions can be packaged in various types of containers with a shelf-stability of up to 2 years. The compositions can be wrapped in a barrier film to increase storage stability. Barriers can include oil wrapping, film, PVA or without a primary wrapping. Additional suitable barrier films can include nylons, polyethylene terephthalate, fluorinated polyethylenes, and copolymers of acrylonitrile and methylmethacrylate. Further the compositions can include a container suitable for containing the tablets, such as for shipping and/or storage. The tablets containing the tablet binding composition provided herein can be stored or shipped in a variety of containers, and the containers can be made of or contain any of a variety of container materials, such as glass, acrylonitrile butadiene styrene (ABS), high impact polystyrene, polycarbonate, high density polyethylene, low density polyethylene, high density polypropylene, low density polypropylene, polyethylene terephthalate, polyethylene terephthalate glycol and polyvinylchloride and combinations thereof. In embodiments the tablet compositions are placed within a container material, such as for example, a corrugated box, a chipboard carton, a flexible plastic pouch, a paper bag, a plastic or glass container, such as a rigid plastic container or a glass container.

### Acid Component

The tablet compositions comprise at least one solid organic acid component. In alternative embodiments the tablet compositions comprise at least one solid organic acid component and optionally at least one solid inorganic acid component sufficient to provide a desired use solution, such as in preferred embodiments a pH less than about 4.

The acid component must be compatible with the other components of the solid tablet composition. In an embodiment the alkalinity source and the acid component beneficially aid in the rapid dissolution of the tablet composition while maintaining the desired use pH range of less than about 4. Without being bound by a particular mechanism of action, the acid component reacts with the alkalinity source to create effervescence to enhance the rate or speed of the physical break-up of the solid composition. Exemplary acid components include an acid or salt thereof. Preferably the acid has an aqueous solubility between 0.1 g/L and 1500 g/L at 20° C., more preferably between 0.25 g/L and 500 g/L at 20° C., most preferably between 0.25 and 100 g/L at 20° C. As used herein, the g/L description refers to the mass of acid added with sufficient aqueous medium (e.g., water) to form one liter of solution.

According to embodiments of the invention the acid components are water soluble and are solid acids.

Exemplary organic acid components include polycarboxylic acids. More preferably, the acid component is a polycarboxylic acid having between 2 and 4 carboxyl groups. More preferably the polycarboxylic acid is a dicarboxylic acid or a tricarboxylic acid. Exemplary organic acid components can acetic, citric, adipic, aspartic, formic, fumaric, lactic, malic, maleic, succinic, glutamic, glycolic, ascorbic, oxalic, monosodium citrate, tartaric, sulfamic and sodium bisulfate, salts of the foregoing, and mixtures thereof. Additional organic acids available in sold form are also suitable for use in the tablet compositions. In an embodiment the solid organic acid used in the tablet compositions is citric acid.

Optional inorganic acid components include sulfuric acid, sodium bisulfate, magnesium sulfate, sodium sulfate, phosphoric acid, nitric acid, hydrochloric acid, and salts thereof. To employ solid inorganic acids sulfate salts (e.g., magnesium sulfate, sodium sulfate or sodium bisulfate) are preferred. In an embodiment the solid inorganic acid used in the tablet compositions is sodium bisulfate.

In some embodiments, the acids are included at weight-% ratio with the alkali metal carbonate and/or bicarbonate effervescent bases from about 6:1 to about 1:5, or preferably from about 6:1 to about 4:1 for a fast dissolving table composition (e.g. about 20 minutes or less in hot or cold water), or from about 1:3 to about 1:4 for a slow dissolving table composition (e.g. about 60 minutes or less in hot or cold water). In addition, without being limited according to the disclosure, all ranges recited are inclusive of the numbers defining the range and include each integer within the defined range.

In some embodiments, the acids are included in the tablet compositions at an amount of at least about 40 wt-% to about 80 wt-%, about 45 wt-% to about 80 wt-%, about 50 wt-% to about 80 wt-%, or about 50 wt-% to about 75 wt-%. In addition, without being limited according to the disclosure, all ranges recited are inclusive of the numbers defining the range and include each integer within the defined range.

In some embodiments, the solid organic acid or salt thereof is included in the tablet compositions at an amount of at least about 20 wt-% to about 50 wt-%, about 25 wt-% to about 50 wt-%, or about 30 wt-% to about 50 wt-%. In addition, without being limited according to the disclosure, all ranges recited are inclusive of the numbers defining the range and include each integer within the defined range.

In some embodiments, the solid inorganic acid or salt thereof is included in the tablet compositions at an amount of at least about 20 wt-% to about 50 wt-%, about 25 wt-% to about 50 wt-%, or about 30 wt-% to about 50 wt-%. In addition, without being limited according to the disclosure, all ranges recited are inclusive of the numbers defining the range and include each integer within the defined range.

According to embodiments the acid concentration (wt-%) in the tablet compositions provide a suitable pH for desired applications of use, including a pH from about 1 to about 6. In preferred aspects, the tablet compositions provide a use solution pH between about 2 and about 4. Without limiting the scope of invention, the numeric ranges are inclusive of the numbers defining the range and include each integer within the defined range.

### Anionic Surfactants

The tablet compositions comprise one or more anionic sulfate and/or sulfonate surfactants. In embodiments additional anionic surfactants can be included as well with the sulfate and/or sulfonates. Anionic surfactants can include carboxylate, sulfonate, sulfate and phosphate as the polar (hydrophilic) solubilizing groups. Of the cations (counter ions) associated with these polar groups, sodium, lithium and potassium impart water solubility; ammonium and substituted ammonium ions provide both water and oil solubility; and calcium, barium, and magnesium promote oil solubility.

In embodiments the tablet compositions comprise an anionic sulfate surfactant, which can include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). In an embodiment preferred anionic sulfate surfactants include, and Sodium lauryl sulfate (SLS).

In embodiments the tablet compositions comprise an anionic sulfonate surfactant, which can include alkyl sulfonates, preferably C1-C122alkyl sulfonates, the linear and branched primary and secondary alkyl sulfonates, and the aromatic sulfonates with or without substituents, preferably C1-C18, C1-C12, C1-C8, or C1-C₄ alkyl benzene or alkyl naphthalene sulfonates. In a further aspect, suitable alkyl sulfonate surfactants include C8-C22 alkyl sulfonates, or preferably C10-C22 alkyl sulfonates. In an exemplary aspect, the anionic alkyl sulfonate surfactant is linear alkyl benzene sulfonic acid (LAS). In an further exemplary aspect, the anionic sulfonate surfactant includes alpha olefin sulfonate (AOS).

Additional anionic surfactants can include carboxylate surfactants such as carboxylic acids (and salts), such as alkanoic acids (and alkanoates), ester carboxylic acids (e.g., alkyl succinates, such as sodium dioctyl sulfosuccinate), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g., alkyl carboxyls). Secondary carboxylates useful in the present compositions include those which contain a carboxyl unit connected to a secondary carbon. The secondary carbon can be in a ring structure, e.g., as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g., N-acyl sarcosinates), taurates (e.g., N-acyl taurates and fatty acid amides of methyl tauride), and the like.

Additional anionic surfactants can include alkyl or alkylaryl ethoxy carboxylates of the following formula: R—O—(CH₂CH₂O)ₙ(CH₂)ₘ—CO₂X (3) in which R is a C₈ to C₂₂ alkyl group or

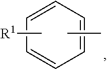

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

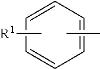

and R¹ is a C₆-C₁₂ alkyl group. In still yet other embodiments, R¹ is a C₉ alkyl group, n is 10 and m is 1.

Exemplary anionic surfactants include linear alkylbenzene sulfonate, sodium dodecylbenzene sulfonate, sodium lauryl sulfate, sodium coco-sulfate, sodium alpha-olefin sulfonate, sodium laureth sulfate, sodium lauroyl sulfoacetate, sodium methyl cocoyl taurate, sodium lauryl sarcosinate, sodium cocoyl isethionte, lauryl glucosides, coco glucosides and combinations thereof. In preferred embodiments, the anionic surfactant comprises linear alkylbenzene sulfonate, sodium lauryl sulfate, and combinations thereof.

In some embodiments, the anionic surfactants are included in the tablet compositions at an amount of at least about 1 wt-% to about 20 wt-%, about 2 wt-% to about 20 wt-%, about 2 wt-% to about 15 wt-%, or about 2 wt-% to about 10 wt-%, or about 4 wt-% to about 10 wt-%. In some embodiments the anionic sulfate and/or sulfonate surfactants are are included in the tablet compositions at an amount of at least about 1 wt-% to about 20 wt-%, about 2 wt-% to about 20 wt-%, about 2 wt-% to about 15 wt-%, or about 2 wt-% to about 10 wt-%, or about 4 wt-% to about 10 wt-%. In addition, without being limited according to the disclosure, all ranges recited are inclusive of the numbers defining the range and include each integer within the defined range. In preferred embodiments a combination of an anionic sulfate and an anionic sulfonate surfactant are included in the compositions. In exemplary embodiments, the tablet compositions include at least one, or at least two of the following anionic sulfate and an anionic sulfonate surfactants: alpha olefin sulfonate (AOS), Linear Alkylbenzene Sulfonate (LAS), and Sodium lauryl sulfate (SLS). In further embodiments an additional anionic surfactant can be included, for example Dioctyl sodium sulfosuccinate (DOSS).

In further preferred embodiments the tablet compositions described herein is free of or does not include the anionic surfactant alkyl cocoyl taurates.

### Effervescent Bases

The tablet compositions comprise at least one effervescent base. These bases are alkalinity sources compatible with the other components of the solid tablet composition that work with the acid components to aid in the rapid dissolution of the tablet composition while maintaining the desired use pH range. A preferred effervescent base is an alkali metal carbonate.

Carbonates can include carbonates and/or bicarbonates. Exemplary sources of alkalinity include alkali metal carbonates and alkali metal bicarbonates, including sodium carbonate, potassium carbonate, sodium bicarbonate, potassium bicarbonate, magnesium carbonate, sodium glycine carbonate, or mixtures thereof, and most preferred is sodium carbonate.

An additional example of a suitable effervescent base for the tablet compositions includes alkali metal percarbonates such as sodium percarbonate and/or a modified anhydrous percarbonate, or an expanded percarbonate salt can also be used as an alkalinity source and a carrier. Expanded percarbonate salts are absorbent bases that are useful for absorbing liquid ingredients (also referred to as a liquid loading agent), although it does not add to the effervescent of a composition. Accordingly, use of a modified anhydrous percarbonate salt as a base is combined with an additional effervescent base as described herein.

The absorption capacity and the ability to absorb larger weights of liquid depends on the carrier's mass, bulk density and porosity. The modified anhydrous percarbonate salt can have a bulk density of about 0-. 62 to 0.7 g/mL and a hydrogen peroxide content of about 0.1 wt-% to less than 24 wt-%. In some preferred embodiments, the modified anhydrous percarbonate salt is a dry solid powder. In some embodiments, a modified anhydrous percarbonate salt is a percarbonate salt with less than about 24 wt-% of hydrogen peroxide. Beneficially the modified anhydrous percarbonate salt can load liquids onto the compound and in embodiments can absorb liquid in an amount up to (or hold up to) about 80 wt-% thereof. Additional disclosure of modified anhydrous percarbonate salts is disclosed in U.S. Pat. No. 8,652,434 the contents of which are incorporated herein by reference in their entirety.

In some embodiments, the effervescent bases are included in the tablet compositions at an amount of at least about 5 wt-% to about 40 wt-%, about 10 wt-% to about 40 wt-%, about 10 wt-% to about 30 wt-%, or about 10 wt-% to about 20 wt-%. In addition, without being limited according to the disclosure, all ranges recited are inclusive of the numbers defining the range and include each integer within the defined range.

In further embodiments, the effervescent bases are included with a modified anhydrous percarbonate salt in the tablet compositions at an amount of at least about 5 wt-% to about 40 wt-%, about 10 wt-% to about 40 wt-%, about 10 wt-% to about 30 wt-%, or about 10 wt-% to about 20 wt-%. In addition, without being limited according to the disclosure, all ranges recited are inclusive of the numbers defining the range and include each integer within the defined range.

### Fillers

The tablet compositions may optionally comprise one or more fillers. In preferred embodiments the tablet compositions comprise at least one filler. Exemplary fillers include polyethylene glycol (PEG) compounds, acetate salts, and C6 saccharide derivatives.

A preferred class of filler includes a polyethylene glycol (PEG) compound, suitable examples including solid polyethylene glycols of the general formula H(OCH₂CH₂)ₙOH, where n is greater than 15, particularly approximately 30 to approximately 1700, such as PEG 4000, PEG 1450, and PEG 8000 among others. It is preferred to use a solid PEG, for example PEG 1500 up to PEG 20,000 as a filler. In certain embodiments, the PEG includes PEG 1450, PEG 3350, PEG 4500, PEG 8000, PEG 20,000, and the like. Suitable solid polyethylene glycols are commercially available from Union Carbide under the tradename CARBOWAX. Use of a PEG filler further provides beneficially effects of binding and lubricating within the tablet while also acting as a water clarifying agent in an aqueous use solution.

Another preferred class of filler includes acetate salts, preferably water-soluble acetate salts. The acetate salt can be a water-soluble acetate salt in anhydrous form. In some applications, the acetate is an anhydrous salt of an alkali metal. Preferred among these are the anhydrous sodium acetate salts and potassium acetate salts. In some applications, the acetate is an anhydrous salt of an alkaline earth metal. Preferred among these are the anhydrous calcium acetate salts and magnesium acetate salts. In some applications, the anhydrous acetate salt composition is selected from among sodium acetate, potassium acetate, calcium acetate, magnesium acetate, sodium diacetate, potassium diacetate and combinations thereof. Acetate salts, including anhydrous forms of acetate salts, are commercially available (e.g., from Niacet Corporation, Niagara Falls, N.Y.; Chem One Ltd., Houston, Tex., USA; Vasa Pharmachem Pvt. Ltd., Gujarat, India; and J&K Scientific GmbH, Pforzheim, Germany).

In preferred embodiments the filler comprises an acetate salt and the acetate salt has a counter ion comprising sodium, potassium, magnesium, calcium, ammonium or combinations thereof, and preferably wherein the counter ion comprises sodium.

Another preferred class of filler includes C6 saccharide derivatives which are amino derivative or a hydrogenated or an oxidized derivative of a sugar that contains six C atoms (aldohexoses and ketohexoses). Exemplary of the C6 saccharide derivatives are the amino hexoses, hexitols, aldonic acids and salts thereof, aldonic acid lactones and salts thereof, hexose-8-lactones and salts thereof, and saccharic acids and salts thereof. As used herein, “amino hexose” refers to a sugar or saccharide having six C atoms that contains an amino group in place of a hydroxyl group. Glucosamine, galactosamine, mannosamine and derivatives of amino containing sugars, such as N-acetylglucosamine, N-acetyl mannosamine and N-acetyl galactosamine are examples of amino hexoses. As used herein, “hexitol” refers to a sugar containing six C atoms in which the aldehyde or ketone group has been reduced (hydrogenated) to an alcohol. Examples of hexitols include allitol, altritol (talitol), fucitol, galactitol (dulcitol), glucitol (sorbitol), iditol, and mannitol. As used herein, an “aldonic acid” refers to any one of a family of sugar acids obtained by oxidation of the aldehyde functional group of an aldose to form a carboxylic acid functional group. As used herein, an “aldonic acid lactone” refers to a lactone of an aldonic acid. The term “lactone” refers a cyclic ester that is the condensation product of a hydroxy group and a carboxylic acid group in the same molecule. As used herein, a “saccharic acid” refers to an oxidized sugar usually produced by oxidizing a sugar with nitric acid, resulting in a compound having the formula C₆H₁₀O₈. In this oxidized form of sugar, the carbon atom bearing the primary hydroxyl group and the aldehydic carbon atom are oxidized to carboxylic acid groups.

Exemplary fillers include for example an oxidized C6 saccharide that is an aldonic acid lactone. Exemplary aldonic acid lactones include allonolactone, altronolactone, gluconolactone, mannolactone, gulonolactone, idonolactone, galactonolactone, talonolactone. In some applications, the C6 saccharide derivative is or contains an aldonic acid lactone selected from among gluconolactone, mannolactone, gulonolactone and galactonolactone and combinations thereof. In some applications, the C6 saccharide derivative is or contains a gluconolactone, preferably a glucono-delta-lactone. The C6 saccharide derivative can contain one or more aldonic acid lactones in combination with another C6 saccharide derivative. Additional examples of exemplary C6 saccharides are set forth in U.S. Pat. No. 11,136,537 which is incorporated herein by reference in its entirety, including for example hexitols such as sorbitol.

In some embodiments, the fillers are included in the tablet compositions at an amount of about 0 wt-% to about 25 wt-%, about 5 wt-% to about 25 wt-%, about 5 wt-% to about 20 wt-%, or about 10 wt-% to about 20 wt-%. In addition, without being limited according to the disclosure, all ranges recited are inclusive of the numbers defining the range and include each integer within the defined range.

In preferred embodiments a C6 saccharide derivative, preferably a glucono-delta-lactone and/or sorbitol, is included in a weight-% concentration of the composition of at least about 5 wt-%, or at least about 10 wt-% to provide processing benefits to reduce stickiness of the solid compositions.

In preferred embodiments an acetate salt is included in a weight-% concentration of the composition from about 1 wt-% to about 10 wt-%, or from about 2 wt-% to about 5 wt-% to provide processing benefits.

In still further preferred embodiments as described herein the tablet compositions include both a C6 saccharide derivative, preferably a glucono-delta-lactone and/or sorbitol, and an acetate salt.

In further preferred embodiments, the ratio of a C6 saccharide derivative, preferably a glucono-delta-lactone, to the acetate salt is from about 5:1 to about 1:5 (weight ratio), or from about 4:1 to about 1:4, and preferably from about 1:5 to about 1:4, or about 1:4.75, 1:4.5, 1:4.25, 1:4, 1:3.75, 1:3.5, 1:3.25, 1:3, 1:2.75, 1:2.5, 1:3.25, 1:2, 1:1.75, 1:1.5, 1:1.25, or 1:1.

### Additional Functional Ingredients

The components of the solid tablet compositions can further be combined with various functional components suitable for uses disclosed herein. In some embodiments, the solid tablet compositions including the acids (solid organic and/or solid inorganic acids), sulfate and/or sulfonate anionic surfactant, alkali metal carbonate and/or bicarbonate effervescent bases, and additional components including for example one or more fillers, a counter ion, a nonionic surfactant, or combinations thereof, make up a large amount, or even substantially all of the total weight of the solid tablet compositions. For example, in some embodiments few or no additional functional ingredients are disposed therein.

In other embodiments, additional functional ingredients may be included in the solid tablet compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used.

In some embodiments, the solid tablet compositions may include additional fillers, solidification agents, optical brighteners, defoaming agents, bleaching agents, solubility modifiers, dispersants, metal protecting agents, stabilizing agents, corrosion inhibitors, chelating agents, enzymes, aesthetic enhancing agents including fragrances and/or dyes, hydrotropes or couplers, buffers, solvents, tablet binders, tablet lubricants, additional cleaning agents including surfactants, and the like, or combinations thereof.

According to embodiments of the disclosure, the various additional functional ingredients may be provided in a solid tablet composition in the amount from about 0 wt-% and about 25 wt-%, from about 0 wt-% and about 20 wt-%, from about 0.01 wt-% and about 25 wt-%, from about 0.01 wt-% and about 20 wt-%, from about 0.1 wt-% and about 10 wt-%, or from about 1 wt-% and about 10 wt-%. In addition, without being limited according to the disclosure, all ranges recited are inclusive of the numbers defining the range and include each integer within the defined range.

### Hydrotropes or Carriers

The tablet compositions can further comprise hydrotropes or carriers. In an embodiment sulfonate can be included, for example, sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, and sodium butyl naphthalene sulfonate. In a preferred embodiment the carrier is sodium xylene sulfonate. Beneficially, in still further embodiments the sulfonate carrier aids in the solidification of the solid compositions and the solid cleaning compositions and further acts as a hydrotrope in solution at a point of use to solubilize hydrophobic compounds, such as soils.

In some embodiments, the hydrotropes or carriers are included in the tablet composition at an amount of at least about 0 wt-% to about 20 wt-%, about 0.1 wt-% to about 10 wt-%, about 0.5 wt-% to about 10 wt-%, or about 1 wt-% to about 10 wt-%. In addition, without being limited according to the disclosure, all ranges recited are inclusive of the numbers defining the range and include each integer within the defined range.

### Additional Surfactants

The tablet compositions can further comprise additional surfactants. Surfactants that can be used include anionic, cationic, amphoteric, zwitterionic, and/or nonionic surfactants, which are commercially available from a number of sources. For a discussion of surfactants, see Kirk-Othmer, Encyclopedia of Chemical Technology, Third Edition, volume 8, pages 900-912. Surfactants can be used alone or in combination. In an embodiment, nonionics and anionics are used in combination. It should be understood that the selection of particular surfactants or combinations of surfactants can be based on a number of factors including compatibility with the surface to be cleaned at the intended use concentration and the intended environmental conditions including temperature and pH.

Zwitterionic or amphoteric surfactants suitable for use with the multipurpose alkaline compositions include beta-N-alkylaminopropionic acids, n-alkyl-beta-iminodipropionic acids, imidazoline carboxylates, n-alky-betaines, amine oxides, sulfobetaines and sultaines.

Nonionic surfactants suitable for use with the multipurpose alkaline compositions include alcohol alkoxylates having EO, PO and BO blocks, fatty acid alkoxylate, alkyl phenol alkoxylates, and polyether (also known as polyalkylene oxide, polyoxyalkylene or polyalkylene glycol) compounds. More particularly, the polyether compounds are generally polyoxypropylene or polyoxyethylene glycol compounds. Typically, the surfactants suitable for use with the multipurpose alkaline compositions are synthetic organic polyoxypropylene (PO)-polyoxyethylene (EO) block copolymers. These surfactants have a diblock polymer comprising an EO block and a PO block, a center block of polyoxypropylene units (PO), and having blocks of polyoxyethylene grated onto the polyoxypropylene unit or a center block of EO with attached PO blocks.

Cationic surfactants suitable for use with the multipurpose alkaline compositions can include alkylamines and their salts, alkyl imidazolines, ethoxylated amines, and quaternaries, such as alkylbenzyldimethylammonium salts, alkyl benzene salts, heterocyclic ammonium salts, tetra alkylammonium salts, and the like. Cationics further include compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced, or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom. Additional description can be in “Surfactant Encyclopedia”, Cosmetics & Toiletries, Vol. 104 (2) 86-96 (1989) and U.S. Pat. No. 9,663,431, which are herein incorporated by reference in its entirety.

Amphoteric surfactants suitable for use with the multipurpose alkaline compositions include derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989) and U.S. Pat. No. 9,663,431, which are herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

In some embodiments, the additional surfactants are included in the tablet composition at an amount of at least about 0 wt-% to about 20 wt-%, about 0.1 wt-% to about 10 wt-%, about 0.5 wt-% to about 10 wt-%, or about 1 wt-% to about 10 wt-%. In addition, without being limited according to the disclosure, all ranges recited are inclusive of the numbers defining the range and include each integer within the defined range.

### Methods of Use

The tablet compositions are suited for a variety of uses both consumer and institutional and beneficially provide commercially acceptable cleaning performance. The tablet compositions are pressed solids that beneficially provide stabilized foaming and fast dissolution times for the tablets thereby enabling their use in various consumer and institutional applications. The tablet compositions are particularly suitable for unit dose delivery of a use solution for a particular application as described herein.

In some aspects, the tablet compositions provide storage space benefits compared to liquid counterparts. Because the tablet compositions do not contain water, the weight and volume associated with water in liquid products may be eliminated, resulting in a reduced storage footprint. In some cases, this can allow for storage of a greater quantity of product in the same space compared to liquid formulations. These benefits may be realized across various storage environments, including warehousing facilities, retail shelving, and consumer storage areas such as cabinets or closets. In institutional settings where storage space may be limited, such as hospitals, restaurants, schools, or commercial cleaning operations, the compact nature of tablet compositions can be particularly advantageous. Additionally, the reduced volume of tablet compositions compared to liquid products may allow for reduced packaging materials, further contributing to sustainability benefits. The ability to store more product in less space can also reduce the frequency of product reordering and delivery, which may provide logistical and cost benefits for both consumers and institutional users.

The tablet compositions provide a use solution having a total active surfactant concentration of from about 650 ppm to about 2000 ppm, or from about 750 ppm to about 1000 ppm. The solid tablet composition that is dissolved for contact with an article or substrate to be cleaned can be referred to as the use solution of the composition.

In embodiments the tablet compositions achieve a fast dissolution, namely a dissolution into a use solution within about 15 minutes or less, about 14 minutes or less, about 13 minutes or less, about 12 minutes or less, about 11 minutes or less, or about 10 minutes or less, about 9 minutes or less, about 8 minutes or less, about 7 minutes or less, about 6 minutes or less, or about 5 minutes or less in an aqueous solution, such as water, at a temperature of at least about 20° C. (68° F.). As one skilled in the art will ascertain the volume of the aqueous solution, such as water, can vary depending upon the size of the tablet composition.

In some embodiments, the tablet compositions can be diluted at a dilution ratio of about 0.1 g/L to about 20 g/L concentrate to diluent, about 0.5 g/L to about 10.0 g/L concentrate to diluent, about 1.0 g/L to about 10.0 g/L concentrate to diluent, or about 3.0 g/L to about 10.0 g/L concentrate to diluent. Without limiting the scope, the numeric ranges are inclusive of the numbers defining the range and include each integer within the defined range.

In further embodiments the tablet compositions achieve a fast dissolution, namely a dissolution into a use solution within about 20 minutes or less, or preferably about 10 minutes or less, in an aqueous solution, such as water, at a temperature of at least about 40° C. (104° F.). Fast dissolution time of 20 minutes or less, or preferably 10 minutes or less is a significant benefit as 10 minutes appropriates the about of time for an average 10-gallon sink to fill to its desired volume within with a tablet composition as described herein with that period of time. As a result there is minimal to no additional waiting time for the tablet composition to dissolve into a use solution. As one skilled in the art will ascertain the volume of the aqueous solution, such as water, can vary depending upon the size of the tablet composition.

In other embodiments a slower dissolution time is desired, namely a dissolution into a use solution within about 60 minutes or less in an aqueous solution, such as water, at a temperature of at least about 40° C. (104° F.).

The designed rapid or slower dissolution of the tablet compositions is achieved with substantially all of the solid is dissolved in the aqueous solution, preferably water. In referring to substantially all of the solid being dissolved this includes about 90% or more of the tablet composition. Dissolution is complete when there is no remaining efflorescence from the tablet composition.

The use solutions of the tablet composition are obtained by dissolving the tablet composition into an aqueous solution, preferably water. The use solution has a pH between about 2 and about 6. In a preferred embodiment, the use solution has a pH between about 2 and about 4.

In an embodiment, the tablet compositions are useful as disinfecting compositions, both consumer (i.e. home use) and institutional. In a preferred embodiment the tablet compositions are particularly well suited for hard surface disinfection. Still further the tablet compositions are also useful as virucidal compositions. This use is suitable for both consumer and institutional use of the hard surface cleaning compositions. The hard surface cleaning and disinfecting can generate a use solution of the tablet composition in a bucket or other vessel for manual hard surface cleaning and disinfecting, such as saturating a wipe, cloth, mop, sponge or the like with the use solution of the tablet composition to contact various hard surfaces for cleaning and disinfecting.

In other embodiments, the tablet composition can be added into a spray bottle or other vessel where a use solution of the tablet composition is generated and thereafter the use solution is sprayed onto a hard surface for cleaning and/or disinfecting.

A particularly well-suited method for applying or contacting the compositions to a stained or soiled surface is through the use of a manually operated spray-dispensing container. The spray-dispensing container preferably includes a spray nozzle, a dip tube and associated pump dispensing parts, providing convenient application to stained or soiled surfaces or objects.

In a further aspect, contacting the compositions can be to a food contact (e.g. food product) and/or non-food contact hard surface. Such surfaces can further include instruments, such as medical instruments. Surfaces can also include those cleaned in third-sink sanitizing, including various wares. In still further aspects, contacting the composition can be to a CIP (clean in place) application.

In some embodiments the use of the compositions to contact a food product can further include a rinsing step thereafter.

In further embodiments the use of the composition to contact a hard surface can further include cleaning and disinfecting floors.

The various applications of use described herein can include beneficially fast-acting applications of use. However, the present methods require a certain minimal contact time of the compositions with the surface or product in need of treatment for occurrence of sufficient cleaning, and antimicrobial effect. The contact time can vary with concentration of the use compositions, method of applying the use compositions, temperature of the use compositions, pH of the use compositions, amount of the surface or product to be treated, amount of soil or substrates on/in the surface or product to be treated, concentration of actives of compositions, and the like. The contact or exposure time can be about 15 seconds, at least about 15 seconds, about 30 seconds or greater than 30 seconds. In some embodiments, the exposure time is about 1 to 5 minutes. In other embodiments, the exposure time is a few minutes to hours.

The present methods can be conducted at any suitable temperature. In some embodiments, the present methods are conducted at a temperature ranging from about 0° C. to about 5° C., e.g., from about 5° C. to about 10° C., 0° C. to about 10° C., 0° C. to about 20° C., 0° C. to about 40° C., 0° C. to about 50° C., 0° C. to about 80° C., or at increased temperatures there above suitable for a particular application of use.

The compositions are suitable for antimicrobial efficacy against a broad spectrum of microorganisms, providing broad spectrum bactericidal and fungistatic activity. For example, the use of the present composition provides broad spectrum activity against wide range of different types of microorganisms (including both aerobic and anaerobic microorganisms, gram positive and gram negative microorganisms), including bacteria, yeasts, molds, fungi, algae, and other problematic microorganisms.

The present methods can be used to achieve any suitable reduction of the microbial population in and/or on the target or the treated target composition. In some embodiments, the present methods can be used to reduce the microbial population in and/or on the target or the treated target composition by at least one log10. In other embodiments, the present methods can be used to reduce the microbial population in and/or on the target or the treated target composition by at least two log10. In still other embodiments, the present methods can be used to reduce the microbial population in and/or on the target or the treated target composition by at least three log10. In still other embodiments, the present methods can be used to reduce the microbial population in and/or on the target or the treated target composition by at least five log10. Without limiting the scope of invention, the numeric ranges are inclusive of the numbers defining the range and include each integer within the defined range.

In preferred methods of use, the treatment of a surface with the aqueous use solutions described herein beneficially results in the surface having greater than 99.9% reduction (3-log order reduction), greater than 99.99% reduction (4-log order reduction), or greater than a 99.999% reduction (5-log order reduction) in a population of microorganisms and/or pathogens on the surface.

Beneficially, the methods do not require a rinse step. In an aspect, the compositions are food contact approved and do not require a rinse step. As a further benefit, the methods do not cause corrosion and/or interfere with surfaces (e.g. hazy, dull or other negative aesthetic effects on the surface).

The methods can optionally include the use of various sensors and/or indicators. In an aspect, the level of active ingredients in use solution can be monitored by various ways. In one approach, the critical pH of the solution at which the product will start to lose its biocidal efficacy significantly is visually indicated by a color change, and the color change is achieved by choosing a dye that show dramatic color change at this pH. The dye could be simply incorporated into the product, and preferably the dye is incorporated into a polymeric substrate to form a color change strip, and the strip will put in the container, for example the 3^{rd} sink to show the color change when the solution pass the critical pH value. Additionally, the level of anionic surfactants in use solution could also be monitored by a similar manner, where a color change will indicate the critical concentration of anionic surfactant needed for biocidal efficacy.

In an additional embodiment, as an alternative to visual indicators, properties of the use solution including pH, anionic activity, fluorescence, and/or conductivity can be monitored by sensors that provide a visual or audible signal when the solution is no longer within a specified range. In some embodiments, a marker molecule can be added to the composition, where the change of the active ingredients in the use solution will trigger the physical and/or chemical property changes of the marker molecule, and the change is quantified through a signal processing.

### EMBODIMENTS

The following embodiments are illustrative of the present disclosure and are not intended to limit the scope thereof.

1. In an embodiment, a solid tablet composition comprises: a solid organic acid or salt thereof; a sulfate and/or sulfonate anionic surfactant; an alkali metal carbonate and/or bicarbonate effervescent base; and at least one additional functional ingredient, preferably comprising a filler, and preferably wherein the weight ratio of solid organic acid or salt thereof to the alkali metal carbonate and/or bicarbonate effervescent base is from about 6:1 to about 1:5.

2. In an embodiment, the composition of Embodiment 1, wherein the solid organic acid or salt thereof comprises from about 20 wt-% to about 80 wt-% of the composition.

3. In an embodiment, the composition of any one of Embodiments 1-2, wherein the solid organic acid or salt thereof comprises one or more of citric acid, malic acid, succinic acid, adipic acid, fumaric acid, benzoic acid, tartaric acid, or any salts thereof.

4. In an embodiment, the composition of any one of Embodiments 1-3, wherein the composition further comprises a solid inorganic acid or salt thereof in an amount that comprises from about 20 wt-% to about 50 wt-% of the composition and comprises bisulfate salts, sulfamic acid or salts thereof, and preferably wherein the weight ratio of the solid organic acid or salt thereof and the solid inorganic acid or salt to the alkali metal carbonate and/or bicarbonate effervescent base is from about 5:1 to about 1:2, or preferably from about 2:1 to about 3:1.

5. In an embodiment, the composition of any one of Embodiments 1-4, wherein the sulfate and/or sulfonate anionic surfactant comprises from about 1 wt-% to about 20 wt-% of the composition, about 2 wt-% to about 20 wt-%, about 2 wt-% to about 15 wt-%, or about 2 wt-% to about 10 wt-%, or about 4 wt-% to about 10 wt-% of the composition.

6. In an embodiment, the composition of any one of Embodiments 1-5, wherein the sulfate and/or sulfonate anionic surfactant comprises at least one of alpha olefin sulfonate (AOS), Linear Alkylbenzene Sulfonate (LAS), and Sodium lauryl sulfate (SLS), and preferably wherein when the sulfate and/or sulfonate anionic surfactant comprise Sodium lauryl sulfate (SLS) and alpha olefin sulfonate (AOS) in a weight ratio of SLS to AOS from about 2:1 to about 1:2, or preferably from about 1.5:1 to about 2:1.

7. In an embodiment, the composition of Embodiment 6, further comprising an additional anionic surfactant in a distinct class from sulfate and/or sulfonate anionic surfactants (such as Dioctyl sodium sulfosuccinate (DOSS)).

8. In an embodiment, the composition of any one of Embodiments 1-7, wherein the alkali metal carbonate and/or bicarbonate effervescent base comprises from about 5 wt-% to about 40 wt-% of the composition, about 10 wt-% to about 40 wt-%, about 10 wt-% to about 30 wt-%, or about 10 wt-% to about 20 wt-% of the composition.

9. In an embodiment, the composition of any one of Embodiments 1-8, wherein the alkali metal carbonate and/or bicarbonate effervescent base comprises sodium carbonate and/or sodium bicarbonate.

10. In an embodiment, the composition of Embodiment 9, further comprising a modified anhydrous percarbonate salt.

11. In an embodiment, the composition of any one of Embodiments 1-10, wherein the filler comprises a polyethylene glycol, an acetate salt, a C6 saccharide derivative (e.g. glucono-delta-lactone or hexitols such as sorbitol) or a combination thereof, and preferably wherein the filler comprises from about 5 wt-% to about 25 wt-%, about 5 wt-% to about 20 wt-%, or about 10 wt-% to about 20 wt-% of the composition, and further preferably wherein the filler comprises at least one C6 saccharide derivative and an acetate salt.

12. In an embodiment, the composition of any one of Embodiments 1-11, wherein the filler comprises an acetate salt, and wherein the acetate salt has a counter ion comprising sodium, potassium, magnesium, calcium, ammonium or combinations thereof, and preferably wherein the counter ion comprises sodium.

13. In an embodiment, the composition of any one of Embodiments 1-12, further comprising a nonionic surfactant, preferably wherein the nonionic surfactant comprises from about 0.1 wt-% to about 10 wt-% of the composition.

14. In an embodiment, the composition of any one of Embodiments 1-13, further comprising one or more additional functional ingredients selected from the group consisting of additional fillers, solidification agents, optical brighteners, defoaming agents, bleaching agents, solubility modifiers, dispersants, metal protecting agents, soil antiredeposition agents, stabilizing agents, corrosion inhibitors, chelating agents, enzymes, aesthetic enhancing agents including fragrances and/or dyes, hydrotropes or couplers, buffers, solvents, tablet binders, tablet lubricants, additional cleaning agents, and combinations thereof.

15. In an embodiment, the composition of any one of Embodiments 1-14, wherein the solid tablets have a dimensional stability of less than about 3% when heated to 120° F. for at least one hour at a relative humidity, or less than about 3% when heated to 104° F. for at least one hour at about 40-65% humidity.

16. In an embodiment, a use solution of a tablet composition comprises: an aqueous solution of the tablet composition according to any one of Embodiments 1-15, wherein the aqueous solution has a pH between about 2 and about 6, preferably about 2 to about 4.

17. In an embodiment, a method of use comprises: adding a tablet composition according to any one of Embodiments 1-15 into an aqueous solution to dissolve the tablet composition to form a use solution within about 60 minutes or less, contacting a surface with the use solution, and disinfecting the surface; or contacting the use solution according to Embodiment 16 with a surface, and disinfecting the surface.

18. In an embodiment, the method of Embodiment 17, wherein the aqueous solution is water.

19. In an embodiment, the method of any one of Embodiments 17-18, wherein the use solution has a pH between about 2 and about 6, or preferably between about 2 and about 4.

20. In an embodiment, the method of any one of Embodiments 17-19, wherein the methods of use do not require use of personal protective equipment.

21. In an embodiment, the method of any one of Embodiments 17-20, wherein the method of use is for consumer and/or institutional applications of use.

22. In an embodiment, the method of any one of Embodiments 17-21, wherein the use solution is formed in a sink, bucket, bottle or other vessel.

23. In an embodiment, the method of Embodiment 22, wherein the use solution is further saturated onto a wipe, cloth, mop or other apparatus to apply to a hard surface.

24. In an embodiment, the method of Embodiment 22, wherein the use solution is further sprayed onto a hard surface.

25. In an embodiment, the method of any one of Embodiments 17-24, further providing virucidal efficacy of at least a 3-log reduction of virus on the surface contacted with the use solution of the tablet composition.

26. In an embodiment, the method of any one of Embodiments 17-25, wherein the tablet composition is between about 2-10 grams tablet per Liter water for dissolution.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following ingredients are utilized in the Examples, in addition to other ingredients described therein:
Adipic acid, a solid organic acid
Alpha olefin sulfonate (AOS), anionic surfactant
Citric acid, a solid organic acid
Dioctyl sodium sulfosuccinate (DOSS)
Expanded sodium percarbonate (ESP) is a modified anhydrous percarbonate salt with a bulk density between about 0.62 to 0.7 g/mL and a hydrogen peroxide content of about 0.1 wt-% to less than 24 wt-%, base and liquid loading agent
Glucono delta lactone (GDL)
Light ash, sodium carbonate, base and effervescent
Linear Alkylbenzene Sulfonate (LAS), anionic surfactant
Malic acid, a solid organic acid
Polyethylene glycol 8000 (PEG 8000)
Sodium acetate
Sodium bicarbonate, base and effervescent
Sodium bisulfate, a solid inorganic acid
Sodium lauryl sulfate (SLS)
Sulfamic acid, a solid inorganic acid

### Example 1

### Impact of Surfactant Selection on Dissolution Time.

The impact of surfactant selection on dissolution time of the solid compositions (tablets) in both 5 grains per gallon (gpg) cold water (60° F.) and hot water (120° F.) were tested for Formulations I-V as shown in Table 2.

TABLE 2

| Ingredient | I | II | III | IV | V |
|---|---|---|---|---|---|
| Citric acid | 54% | 60% | 50% | 50% | 51% |
| Anionic | — | 20% | 20% | 10% | 5% |
| surfactant | | | | | |
| Sodium | 46% | 20% | 30% | 40% | 44% |
| bicarbonate | | | | | |
| Total | 100% | 100% | 100% | 100% | 100% |

To perform the dissolution time test, tablets according to Formulations I-V were prepared and then submerged in water baths to assess dissolution in cold versus hot water. The water temperature of the bath of cold water was at 60° F. and a separate bath of hot water was at 120° F. The dissolution time in minutes of the tablets were recorded for each water bath, with the time stopped when the entire tablet was dissolved as observed when no further effervescence was observed. The goal for cold and hot water tablet dissolution testing is to achieve a cold-water dissolution that is no more than double the hot water dissolution, and for a total dissolution time for hot water conditions to be about 10 minutes or less, and cold water conditions to be about 15 minutes or less. The results of which are shown in Table 3 reported in minutes to complete dissolution in the 5 gpg water at cold/hot temperatures.

TABLE 3

| Water | | | | | |
|---|---|---|---|---|---|
| Temperature | I | II | III | IV | V |
| Cold (60° F.) | 1:00 | 20:00 | 19:00 | 18:00 | 18:00 |
| Hot (120° F.) | 0:10 | 11:00 | 14:00 | 12:00 | 12:00 |
| Ratio | N/A | 1.2:1 | 0.67:1 | 0.25:1 | 0.11:1 |
| AOS:Bicarb | | | | | |

As may be seen from the results of Table 3, the addition of AOS into Formulation II (compared to I) significantly increases the dissolution time of the tablet. The weight ratio of AOS anionic surfactant to sodium bicarbonate were evaluated for impact on ratio on dissolution time. From these results a qualitative trend was observed, in which formulations with increasing concentrations of AOS anionic surfactant had a longer dissolution time, which can be in part addressed with increasing effervescence of the tablet composition to assist in increasing the rate of dissolution. These results are illustrative of increased need for effervescence of tablets as concentrations of some anionic surfactants increase in order to formulate tablet compositions that achieve desired dissolution times of less than 15 minutes, or less than 10 minutes depending on the water temperature thereof.

### Example 2

### Impact of Surfactant Selection on Hard Water Clarity and Hard Water Tolerance.

The impact of anionic surfactant selection on hard water clarity and hard water tolerance was tested for the solid compositions according to Formulations VI (A-C)-VIII as shown in Table 4.

TABLE 4

| Ingredient | VI (A) | VI (B) | VI (C) | VII | VIII |
|---|---|---|---|---|---|
| Citric acid | 39.0% | 39.0% | 39.0% | 38.0% | 37.0% |
| Sodium | 30.0% | 30.0% | 30.0% | 30.0% | 30.0% |
| bisulfate | | | | | |
| Glucono delta | 8.0% | 8.0% | 8.0% | 8.0% | 8.0% |
| lactone | | | | | |
| Sodium acetate | 5.5% | 5.5% | 5.5% | 5.5% | 5.5% |
| Sodium | 2.5% | 2.5% | 2.5% | 2.5% | 2.5% |
| carbonate | | | | | |
| LAS | 15.0% | 15.0% | 15.0% | 15.0% | 15.0% |
| PEG 8000 | — | — | — | 1% | 2% |
| Total | 100% | 100% | 100% | 100% | 100% |
| pH | 7 | 2 | 3 | — | — |

To perform the hard water clarity test, 7% use solutions of the evaluated formulations were prepared in 17 gpg water. The prepared use solutions of the evaluated formulations were then transferred to beakers which were then subsequently covered with a parafilm to prevent evaporation. The parafilm covered beakers were then allowed to sit in ambient temperature for 5 days, after which the use solutions of the evaluated formulations were assessed for hard water clarity. A cloudy and/or precipitating formula was deemed to have failed the hard water clarity test, and a clear formula was deemed to have passed the hard water clarity test.

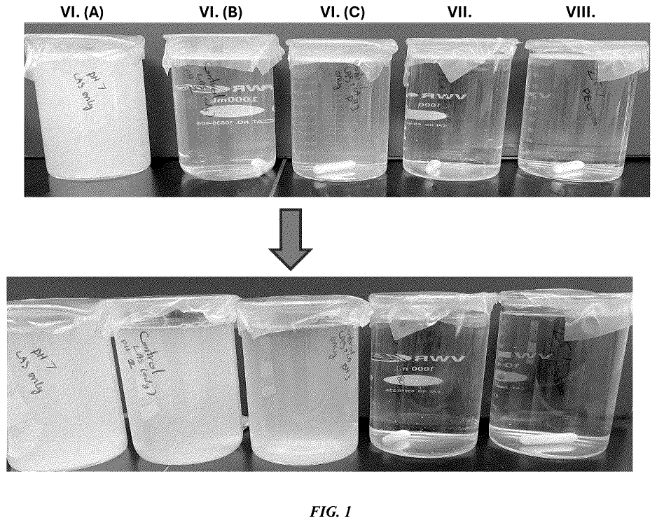

The results of the hard water clarity test are shown in FIG. 1 which shows formulations VII and VIII (including 1% and 2% PEG 8000, respectively) passed the hard water clarity test, whereas formulations VI (A-C) (No PEG 8000) failed the hard water clarity test. The results were unexpected in that a small amount of PEG 8000, used as a binder and/or lubricant for tableting, provided beneficial water clarifying effects to counteract the water hardness present when formulated with the anionic surfactant.

Next the same methodology was used to further assess the hard water tolerance of solid compositions shown in Table 5, each including the PEG 8000 following the water clarity assessment.

TABLE 5

| Ingredient | IX | X | XI | XII |
|---|---|---|---|---|
| Citric acid | 50.00% | 50.00% | 50.00% | 50% |
| Sulfamic acid | 6.00% | 12.00% | 5.00% | — |
| Adipic acid | 5.00% | — | 5.00% | 7.78% |
| GDL | 13.00% | 11.00% | 9.50% | 12.00% |
| LAS | 3.00% | — | — | — |
| Sodium acetate | 3.00% | 2.50% | 2.40% | 8% |
| Light ash | 15.00% | 12.1% | 12.20% | 13.4% |
| PEG8000 | 1.60% | 1.00% | 1.50% | 1.50% |
| SLS | — | 8.00% | 8.00% | 4.50% |
| DOSS | 3.00% | 3.00% | 3.00% | — |
| AOS | | — | 3.00% | 2.40% |
| Additional | 0.40% | 0.4% | 0.40% | 0.42% |
| functional | | | | |
| ingredients | | | | |
| (e.g. dyes, | | | | |
| fragrance) | | | | |
| Total | 100% | 100% | 100% | 100% |
| Hard Water | PASS | FAIL | FAIL | PASS |
| Tolerance | | | | |
| (17gpg) | | | | |

To perform the hard water tolerance test, 7% use solutions of the evaluated formulations IX-XII were prepared in 17 gpg water. The same methodology was used, where hard water tolerance was assessed after the overnight testing, a cloudy and/or precipitating formula was deemed to have failed the hard water tolerance test, and a clear formula was deemed to have passed the hard water tolerance test.

As Table 5 shows, Formulations IX and XII passed the hard water tolerance test. Without being limited by theory of the invention, both the synergistic combination of anionic surfactants (SLS with AOS) in Formulation XII, and the LAS in Formulation IX beneficially resulted in the hard water tolerance. Again, without being limited by theory, it is believed that formulation XI, which is inclusive of SLS/AOS failed the hard water tolerance test as a result of the inclusion of sulfamic acid without the inclusion of LAS.

The results according to the Example provide data showing that the solid compositions are formulated to address hard water concerns, as are found in various cleaning applications. The ability to achieve hard water clarity and hard water tolerance is beneficially as it will overcome conventional cleaning concerns such as streaking in various applications of use with hard water.

### Example 3

### Impact of Surfactant Selection on Streaking.

The impact of anionic surfactant selection on streaking was further tested for Formulations XIII-XVI as shown in Table 6. The results are summarized in the tablet with whether or not each formulation exhibited a streaking rating of Good or Poor (based on visual assessment).

TABLE 6

| Ingredient | XIII | XIV | XV | XVI |
|---|---|---|---|---|
| Citric acid | 50.00% | 50.00% | 50.00% | 50% |
| Sulfamic acid | 6.00% | 6.00% | 6.00% | — |
| Adipic acid | 5.00% | 5.00% | 5.00% | 7.80% |
| Glucono delta | 13.00% | 10.00% | 9.60% | 12% |
| lactone | | | | |
| Sodium acetate | 3.00% | 3.00% | 2.00% | 8% |
| Light ash | 15.00% | 13.00% | 13.00% | — |
| Sodium | — | — | — | 12.50% |
| bicarbonate | | | | |
| Expanded | — | — | — | 1% |
| sodium | | | | |
| percarbonate | | | | |
| PEG 8000 | 1.60% | 1.60% | 3.00% | 1.50% |
| SLS | — | 8.00% | 8.00% | 4.50% |
| DOSS | 3.00% | 3.00% | 3.00% | — |
| LAS | 3.00% | — | — | — |
| AOS | — | — | — | 2.40% |
| Additional | 0.40% | 0.40% | 0.40% | 0.30% |
| functional | | | | |
| ingredients | | | | |
| (e.g. dyes, | | | | |
| fragrance) | | | | |
| Total | 100% | 100% | 100% | 100% |
| Streaking | Good | Poor | Good | Good |
| Rating | | | | |

To perform the streaking test, 7% use solutions of the evaluated formulations were prepared in 5 gpg water. Mirror panels were cleaned with acetone and deionized water and then wiped clean with a lint free cloth. Next 0.2 grams (g) of the 7% use solution were applied to a polyester wipe cut to 1″×1″. A cleaned mirror panel was then wiped horizontally with a wipe containing 0.2 g of the 7% use solution to cover the length of the mirror panel. Subsequently, the mirror panels were allowed to dry for 1 hour, after which the steaking was assessed. Visible steaks covering the mirror panel resulted in a poor steaking rating, whereas a few steaks with a mostly clear mirror panel resulted in a good steaking rating.

As Table 6 shows, Formulations XIII, XV, and XVI demonstrated a “Good” streaking rating, whereas Formulation XVI demonstrated a poor streaking rating. The results show that formulations that do not streak include those with SLS and DOSS or SLS and AOS as the surfactants, and moreover that the SLS and DOSS formulations benefit from inclusion of PEG.

### Example 4

### Impact of Surfactant Selection on Microbial Efficacy.

The impact of anionic surfactant selection on microbial efficacy was tested for Formulations XVII-XXI as shown in Table 7.

TABLE 7

| Ingredient | XVII | XVIII | XIX | XX | XXI |
|---|---|---|---|---|---|
| Citric acid | 39.9% | 50.0% | 39.0% | 50.0% | 50.0% |
| Sulfamic acid | — | 11.6% | — | — | — |
| Adipic acid | — | — | — | — | 7.8% |
| Malic acid | — | — | — | 9.0% | — |
| Sodium | 30.7% | — | 30.0% | — | — |
| bisulfate | | | | | |
| Glucono delta | 7.2% | 12.0% | 7.0% | 16.5% | 12.0% |
| lactone | | | | | |
| Sodium acetate | 2.6% | 3.0% | 2.4% | 1.0% | 8.0% |
| PEG 8000 | 1.0% | 3.0% | 1.0% | 1.2% | 1.5% |
| Sodium | 13.0% | 13.0% | 15.0% | — | — |
| carbonate | | | | | |
| Sodium | — | — | — | 12.0% | 12.5% |
| bicarbonate | | | | | |
| Expanded | — | — | — | 1.0% | 1.0% |
| sodium | | | | | |
| percarbonate | | | | | |
| LAS | 5.6% | 4.0% | 5.6% | — | — |
| SLS | — | — | — | 4.5% | 4.5% |
| DOSS | — | 3.0% | — | — | — |
| AOS | — | — | — | 4.5% | 2.4% |
| Additional | — | 0.4% | — | 0.3% | 0.3% |
| Functional | | | | | |
| Ingredients | | | | | |
| Total | 100% | 100% | 100% | 100% | 100% |
| pH | 2.96 | 3.05 | 3.2 | 3.16 | 3.64 |

The formulations of Table 7 were subjected to either a Food Contact Sanitizing (FCS, MS009) or a GST Disinfection (MS010) microbiology test wherein the formulations efficacy was tested against Staphylococcus aureus.

To perform the food contact sanitizing microbial efficacy testing, samples were prepared to provide the active level of chemistry listed in Table 7 in 400 ppm hard synthetic water. Synthetic water was AOAC hard water of 400 ppm calcium carbonate. The pH of these solutions was measured and recorded. Staphylococcus aureus (Staph) strain ATCC 6538 was tested following ASTM E1053-11. Chemistry was tested in duplicate over three different tests for a total of six replicates with complete inactivation (no surviving organisms) required of all replicates to be considered a passing result. In Example 4, the virus titer was 6.5-7 log. If a failure was observed before six replicates were tested the test was ended and reported as a failure. Example 4 shows a high challenge test that identifies chemistries that are robustly able to reduce viral populations in support of public health and food safety interests.

To perform the GST Disinfection microbiology efficacy testing, bactericidal efficacy screening was conducted with the chemistries of Table 7 following EN1276 using Staphylococcus aureus (Staph) ATCC 6538 at an 8 minute contact. The concentrate chemistries were prepared by adding materials as outlined in Table 7 to a glass beaker and stirred with a stir bar until homogeneous. On the test date, wt. dilutions were prepared of the test chemistries at 7-9 g tablets/1000 mL according to the Table 7 with EN hard water as the diluent. pH was measured with a pH meter and recorded.

The testing was conducted under clean conditions (meaning the treated panels had a soil level of 0.3 g/L bovine serum albumin) at 20° C. with an 8 minute contact time using EN hard water.

The results of the microbial efficacy of Formulations XVII-XXI are shown in Table 8.

TABLE 8

| | | | Micro Test | | Pass | |
|---|---|---|---|---|---|---|
| Formula | pH | Active | Type | Organism | Criteria | Result |
| XVII | 2.96 | LAS | Food | Staph | >5.0 | Pass |
| | | | Contact | | | >7.11, |
| | | | Sanitizing | | | >7.11 |
| XVIII | 3.05 | LAS | Food | Staph | >5.0 | Pass |
| | | | Contact | | | >7.11, |
| | | | Sanitizing | | | >7.11 |
| XIX | 3.2 | LAS | Food | Staph | >5.0 | Fail |
| | | | Contact | | | 4.22, 4.84 |
| | | | Sanitizing | | | |
| XX | 3.16 | SLS | GST | Staph | 59/60 | Pass |
| | | | Disinfection | | | 60/60 |
| XXI | 3.64 | SLS | GST | Staph | 59/60 | Pass |
| | | | Disinfection | | | 60/60 |

The Food Contact Sanitizing (FCS, MS009) requires a >5 log reduction for passing result and the GST Disinfection (MS010) microbiology test requires 59/60 carriers with no growth (total surface kill) for passing result.

As may be seen from the results of Table 8, formulations XVII, XVIII, XX, and XXI achieved the pass criteria and demonstrated microbial efficacy according to either the Food Contact Sanitizing (FCS, MS009) or a GST Disinfection (MS010) microbiology test. Formulation XIX failed to meet the pass criteria and therefore failed to demonstrate sufficient microbial efficacy. The results of Table 8 demonstrate that formulations with an LAS active require a pH of roughly <3.0 to pass, whereas formulations with an SLS active can pass at a greater pH up to 3.7.

### Example 5

### Impact of Surfactant Selection on Antiviral Efficacy.

Antiviral efficacy testing was conducted with the chemistries of formulation XII and XX as shown in Table 9 using Herpes simplex virus type 1 (HSC1), Herpes simplex virus type 2 (HSV2), adenovirus, Rhinovirus, Influenza B, Influenza A virus subtype H3N2 (H3N2), and Influenza A virus subtype H1N1 (H1N1) at a 30 second contact time, and Murine norovirus (MNV) at a 3 minute contact time.

The concentrate chemistries were prepared by adding materials as outlined in Table 9 below to a glass beaker and stirred with a stir bar until homogeneous. On the test date, 7-9 g tablets were dissolved in 1000 mL water (which considers dilution that takes place within the micro efficacy method) according to the tables below with EN hard water as the diluent.

In each test, there was one replicate per test condition. The lab carried these out at room temperature under clean conditions using EN hard water.

TABLE 9

| | XII | XX |
|---|---|---|
| Citric acid | 50.0% | 50.0% |
| Sulfamic acid | — | — |
| Adipic acid | 7.78% | — |
| Malic acid | — | 9.0% |
| Sodium bisulfate | — | — |
| Glucono delta lactone | 12.00% | 16.5% |
| Sodium acetate | 8% | 1.0% |
| PEG 8000 | 1.50% | 1.2% |
| Light Ash | 13.4% | — |
| Sodium carbonate | — | — |
| Sodium bicarbonate | — | 12.0% |
| Expanded sodium | — | 1.0% |
| percarbonate | | |
| LAS | — | — |
| SLS | 4.50% | 4.5% |
| DOSS | — | — |
| AOS | 2.40% | 4.5% |
| Additional Functional | 0.42% | 0.3% |
| Ingredients | | |
| Total | 100% | 100% |

TABLE 10

| | | Contact | Log Starting | Log |
|---|---|---|---|---|
| Composition | Organism | Time | Population | Reduction |
| XII | HSVI | 0:30 | 5.5 | ≥5.00 |
| XX | HSVI | 0:30 | 5.5 | ≥5.00 |
| XII | HSVII | 0:30 | 5 | ≥4.50 |
| XX | HSVII | 0:30 | 5 | ≥4.50 |
| XII | MNV | 3:00 | 5 | 4.25 |
| XX | MNV | 3:00 | 5 | 1.75 |
| XII | Adenovirus | 0:30 | 5 | ≥4.50 |
| XX | Adenovirus | 0:30 | 5 | ≥4.50 |
| XII | Rhinovirus | 0:30 | 5 | ≥4.50 |
| XX | Rhinovirus | 0:30 | 5 | ≥4.50 |
| XII | Influenza B | 0:30 | 6 | ≥5.50 |
| XX | Influenza B | 0:30 | 6 | ≥5.50 |
| XII | H3N2 | 0:30 | 5.75 | ≥5.25 |
| XX | H3N2 | 0:30 | 5.75 | ≥5.25 |
| XII | H1N1 | 0:30 | 5.5 | ≥5.00 |
| XX | H1N1 | 0:30 | 5.5 | ≥5.00 |

The results of Table 10 confirm the antiviral efficacy of the compositions of formulas XII and XX. The results confirm that Murine Norovirus surrogate efficacy of the composition is less significant as alcohol based cleaners are more responsive and achieve a greater log reduction than the evaluated formula XX, even with an increased contact time (i.e. 10 minutes).

### Example 6

### Impact of Formulation Variations on Dissolution Rate.

The impact of formulation variations on dissolution rate was evaluated to demonstrate how dissolution rate can be controlled by adjusting formulation parameters. Three formulations were prepared with variations in effervescent base concentration (light ash and sodium bicarbonate) and anionic surfactant concentration as shown in Table 11.

TABLE 11

| | Formula 1 | Formula 2 | Formula 3 |
|---|---|---|---|
| Malic acid | 0% | 9% | 9% |
| Citric acid | 50.00% | 50.10% | 50.10% |
| Adipic acid | 7.00% | 0 | 0 |
| GDL | 17.00% | 16.50% | 16.50% |
| Sodium acetate | 3.00% | 1% | 1% |
| Light ash (sodium carbonate) | 10.00% | 0% | 0% |
| Sodium bicarbonate, HT | 2.50% | 12.00% | 2.00% |
| PEG8000 | 1.50% | 1% | 1% |
| SLS | 4.50% | 4.50% | 9.50% |
| AOS | 3.00% | 4.50% | 9.50% |
| ESPC | 1.0% | 1% | 1% |
| Dissolution in Hot Water (min) | 11 min | 14 min | 35 min+ |

Between Formula 1 and Formula 2, there is a decrease in light ash (from 10% to 0%) and an increase in anionic surfactant, which increases the dissolution time from 11 minutes to 14 minutes. Taking the Formula 2 a step further by doubling the anionic surfactants (SLS and AOS each increased to 9.50%) and removing almost all the sodium bicarbonate (reduced from 12% to 2%) more than doubles the dissolution time to 35 minutes or more as shown for Formula 3.

The results demonstrate that decreasing effervescent bases (light ash and sodium bicarbonate) and increasing anionic surfactant concentrations results in slower dissolution times, allowing formulators to tailor dissolution rate for specific applications.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A solid tablet composition comprising:
a solid organic acid or salt thereof;
a sulfate and/or sulfonate anionic surfactant;
an alkali metal carbonate and/or bicarbonate effervescent base;
and at least one additional functional ingredient.

2. The composition of claim 1, wherein the solid organic acid or salt thereof comprises from about from about 20 wt-% to about 80 wt-% of the composition.

3. The composition of claim 1, wherein the solid organic acid or salt thereof comprises one or more of citric acid, malic acid, succinic acid, adipic acid, fumaric acid, benzoic acid, tartaric acid, or any salts thereof.

4. The composition of claim 1, wherein the composition further comprises a solid inorganic acid or salt thereof in an amount that comprises from about 20 wt-% to about 50 wt-% of the composition and comprises bisulfate salts, sulfamic acid or salts thereof, and/or wherein the weight ratio of the solid organic acid or salt thereof and the solid inorganic acid or salt to the alkali metal carbonate and/or bicarbonate effervescent base is from about 5:1 to about 1:2.

5. The composition of claim 1, wherein the sulfate and/or sulfonate anionic surfactant comprises from about 1 wt-% to about 20 wt-% of the composition.

6. The composition of claim 1, wherein the sulfate and/or sulfonate anionic surfactant comprises at least one of alpha olefin sulfonate (AOS), Linear Alkylbenzene Sulfonate (LAS), and Sodium lauryl sulfate (SLS), and optionally wherein when the sulfate and/or sulfonate anionic surfactant comprise Sodium lauryl sulfate (SLS) and alpha olefin sulfonate (AOS) in a weight ratio of SLS to AOS from about 2:1 to about 1:2.

7. The composition of claim 6, further comprising an additional anionic surfactant in a distinct class from sulfate and/or sulfonate anionic surfactants (such as Dioctyl sodium sulfosuccinate (DOSS)).

8. The composition of claim 1, wherein the alkali metal carbonate and/or bicarbonate effervescent base comprises from about 5 wt-% to about 40 wt-% of the composition, and/or wherein the alkali metal carbonate and/or bicarbonate effervescent base comprises sodium carbonate and/or sodium bicarbonate.

9. The composition of claim 8, further comprising a modified anhydrous percarbonate salt.

10. The composition of claim 1, wherein the filler comprises a polyethylene glycol, an acetate salt, a C6 saccharide derivative (e.g. glucono-delta-lactone or hexitols such as sorbitol) or a combination thereof, and wherein the filler comprises from about 5 wt-% to about 25 wt-% of the composition.

11. The composition of claim 1, wherein the filler comprises an acetate salt, and wherein the acetate salt has a counter ion comprising sodium, potassium, magnesium, calcium, ammonium or combinations thereof.

12. The composition of claim 1, further comprising a nonionic surfactant, wherein the nonionic surfactant comprises from about 0.1 wt-% to about 10 wt-% of the composition.

13. The composition of claim 1, further comprising one or more additional functional ingredients selected from the group consisting of additional fillers, solidification agents, optical brighteners, defoaming agents, bleaching agents, solubility modifiers, dispersants, metal protecting agents, soil antiredeposition agents, stabilizing agents, corrosion inhibitors, chelating agents, enzymes, aesthetic enhancing agents including fragrances and/or dyes, hydrotropes or couplers, buffers, solvents, tablet binders, tablet lubricants, additional cleaning agents, and combinations thereof.

14. The composition of claim 1, wherein the solid tablets have a dimensional stability of less than about 3% when heated to 120° F. for at least one hour at a relative humidity, or less than about 3% when heated to 104° F. for at least one hour at about 40-65% humidity.

15. A use solution of a tablet composition comprising:
an aqueous solution of the tablet composition according to claim 1, wherein the aqueous solution has a pH between about 2 and about 6.

16. A method of use comprising:
adding a tablet composition according to claim 1 into an aqueous solution to dissolve the tablet composition to form a use solution with a pH between about 2 and about 6 within about 60 minutes or less, contacting a surface with the use solution, and disinfecting the surface.

17. The method of claim 16, wherein the aqueous solution is water.

18. The method of claim 16, wherein the methods of use do not require use of personal protective equipment, and wherein the method of use is for consumer and/or institutional applications of use.

19. The method of claim 16, wherein the use solution is formed in a sink, bucket, bottle or other vessel, or wherein the use solution is further saturated onto a wipe, cloth, mop or other apparatus to apply to a hard surface, and/or wherein the use solution is further sprayed onto a hard surface.

20. The method of claim 16, further providing virucidal efficacy of at least a 3-log reduction of virus on the surface contacted with the use solution of the tablet composition.

21. The method of claim 16, wherein the tablet composition is between about 2-10 grams tablet per Liter water for dissolution.
